(19) United States
(12) Patent Application Publication
(10) Pub. No.: US 2022/0092148 A1
(43) Pub. Date: Mar. 24, 2022

(54) METHODS AND SYSTEMS FOR CROSS-DOMAIN TWO-WAY COMMUNICATION BY DYNAMIC WEB CONTENT

(71) Applicant: CONTENT DIRECTIONS, INC. DBA LINKSTORM, New York, NY (US)

(72) Inventors: Timothy Donald Ross, West Hartford, CT (US); Christopher Schacht, New York, NY (US)

(73) Assignee: CONTENT DIRECTIONS, INC. DBA LINKSTORM, New York, NY (US)

(21) Appl. No.: 17/214,033

(22) Filed: Mar. 26, 2021

Related U.S. Application Data
(60) Provisional application No. 63/081,157, filed on Sep. 21, 2020.

(51) Int. Cl. G06F 16/958; G06Q 30/02; G06F 16/955; G06F 16/957

(52) U.S. Cl. CPC G06F 16/972; G06F 16/9577; G06F 16/9558; G06Q 30/0277

(57) ABSTRACT

A method of modifying a first webpage from a first domain to enable cross-domain two-way communication is disclosed. The method comprising causing a web browser to load, as part of the first webpage, dynamic content comprising a UI to embed an iFrame into the first webpage that contains a second webpage from a second domain different from the first domain; to load a script file from within the iFrame; to bind one or more functions defined by the script file to the UI; to, in response to the user interacting with the UI, using the one or more functions to send a message to the second domain; and to, after receiving a response from a server at the second domain, update the UI in response to the received response. The method also enables a seamless, cross-domain user interface that maintains synchronization between webpages on different domains.

### CROSS REFERENCE TO RELATED APPLICATION

This application is a non-provisional claiming the benefit of U.S. Provisional Pat. App. No. 63/081,157, filed Sep. 21, 2020 and also titled “METHODS AND SYSTEMS FOR CROSS-DOMAIN TWO-WAY COMMUNICATION BY DYNAMIC WEB CONTENT,” which is hereby incorporated in full by reference.

### FIELD OF INVENTION

The present innovations generally address web frame and graphic compositing, and more particularly, to systems and methods for a Supra Boundary Web Compositor, directly linking via two-way communication a digital advertisement or other imported content displayed on a first website to server-side functionality of a second website, such as a shopping cart of that website.

### BACKGROUND

The “holy grail” of the advertising industry has always been the ability to prove a direct connection between an advertisement and a purchase. But this goal has eluded advertisers. The industry's most famous quote, attributed to John Wanamaker, reads: “I know that half my advertising budget is wasted; the problem is I don't know which half!”

Even with the subsequent advent of the Internet, when digital advertising enabled a plethora of types of measurement of consumer behavior in relation to digital advertisements, sophisticated measurements of other consumer behavior on the Internet, and extremely elaborate uses of both online and offline data to target consumers with more effective advertising—all in hopes of documenting a direct connection between an advertisement and the consumer's subsequent action—it has only been possible to draw an indirect, inferred connection between the consumer's exposure to an advertisement and that consumer's subsequent behavior.

Further, even when an indirect connection is able to be inferred, it is almost impossible to attribute credit exclusively to the particular advertisement that was viewed, versus acknowledging the possibility that many other sources of motivation may have been at work, such as the viewing of other/different advertisements, exposure to other marketing mechanisms both online and offline (from Linear Television to Roadside Billboards), etc.

Additionally, interactive methods of advertising are often hampered by security settings in users' web browsers, which prevent AJAX (Asynchronous Javascript and XML) function calls from one domain to another. These function calls are the backbone of interactive web browsing and enable web pages to dynamically load content from an external source. Because the loading of content from an arbitrary source can be a significant security risk, many modern browsers allow only AJAX calls to the same domain. Thus, all data sources must be stored (or at least appear to be stored) in a single domain, creating an arbitrary restriction on dynamic content, forcing unnecessary architectural design decisions such as server-side workarounds to deal with the limitation, and hampering cooperation/integration from multiple data sources that could be best used to serve the consumer. Alternatively, a user who wants to access a website that attempts to draw from multiple data sources will have to use a browser that permits ultra-low security settings and deal with the inconvenience and danger of exposure to cross-domain scripting attacks while browsing the Internet.

Thus, there are advantages to having a system that can create advertisements that more directly link the advertisement to the purchase, as well as to systems that facilitate cross-domain communication for more functional ads.

### SUMMARY

Ad-to-Cart (“A2C”) communication provides an elegant solution for linking a digital advertisement directly to a purchase on a merchant's website by literally linking the advertisement to the website's shopping cart and vice-versa (creating bidirectional communication and passing of data), such that a consumer can shop the merchant's online store directly within the advertisement itself, selecting products for purchase and adding them directly to a shopping cart within the advertisement that is in fact a direct instantiation of the shopping cart on the merchant's website. The shopping cart within the digital advertisement contains all the functionality and behaviors of the cart on the website itself, such as displaying an automatically-incrementing counter showing the number of items in the cart, and when the consumer clicks or taps the cart icon to proceed to check-out, the consumer is taken directly into the shopping cart on the merchant's website with all the selected products still populating the cart.

The direct communication between advertisement and cart is bidirectional, so that if the consumer further modifies the cart on the merchant's website and then returns to the advertisement, all such modifications remain reflected in the cart within the advertisement. And if further modifications are made within the advertisement, they are also reflected in the cart on the website.

In this way, the advertisement is being linked directly/literally to the purchase, with no room for doubt that the advertisement is directly driving the purchase.

Further, this invention represents an orders-of-magnitude leap in advertisement effectiveness, providing the consumer with instant gratification and providing the advertiser with a shorter, direct funnel from advertisement exposure to purchasing.

The presently-described systems and methods enable the consumer to add to cart continuously within the advertisement, and then check out once with a single click or tap. This bidirectional communication between advertisement and cart is enabled by an iFrame (“inline frame”), placed on the merchant's website, which is able to communicate directly with the website's shopping cart application in the same way that an actual consumer would be able to communicate directly/manually with the shopping cart.

In one aspect of this disclosure, a method for modifying a first webpage to enable cross-domain two-way communication is disclosed. The method includes loading, in the first webpage, dynamic content comprising one or more user interface elements. An iFrame is embedded into the first webpage whose source is set to a second webpage. A script file including an executable program, such as (but not limited to) a Javascript file, is loaded using the iFrame and one or more functions defined by the script file are bound to the one or more user interface elements. When the user interacts with the one or more user interface elements, the one or more functions are used to send a message to the second webpage, a response is received from the second webpage, and to update the one or more user interface elements in response to the received response.

### BRIEF DESCRIPTION OF THE DRAWINGS

Other aspects, features and advantages will become more fully apparent from the following detailed description, the appended claims, and the accompanying drawings, provided solely for purposes of illustration without restricting the scope of any embodiment:

FIG. 1 depicts a network of computing devices to be used in a system for providing webpages that comprise interactive content with two-way cross-domain communication capabilities;

FIG. 2 depicts a pair of user interfaces that are modified and combined by means of methods and systems described herein;

FIG. 3 depicts a method for augmenting a web-based user interface to add two-way, cross-domain communication with a different website from the one being augmented;

FIGS. 4A-4G depict a concrete user experience that may be accomplished using the presently described technology; and

FIG. 5 is a high-level block diagram of a representative computing device that may be utilized to implement various features and processes described herein.

### DETAILED DESCRIPTION

In order to address the issues described above, methods and systems are provided to facilitate two-way communication between an advertisement or other content dynamically loaded in a first website and a second website that provides a user interface that a user might wish to interact with via the advertisement or other content.

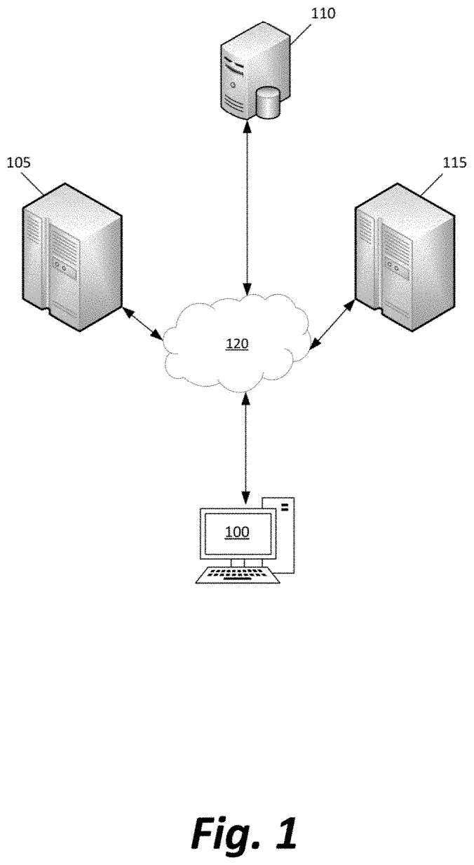

FIG. 1 depicts a network of computing devices to be used in a system for providing webpages that comprise interactive content with two-way cross-domain communication capabilities.

A user computing device 100 with software including a web browser is used to connect to the Internet 120 or another similar network. The user computing device 100 may be a PC, a mobile phone, a gaming console, or any other device capable of running a web browser to display a webpage to a human user.

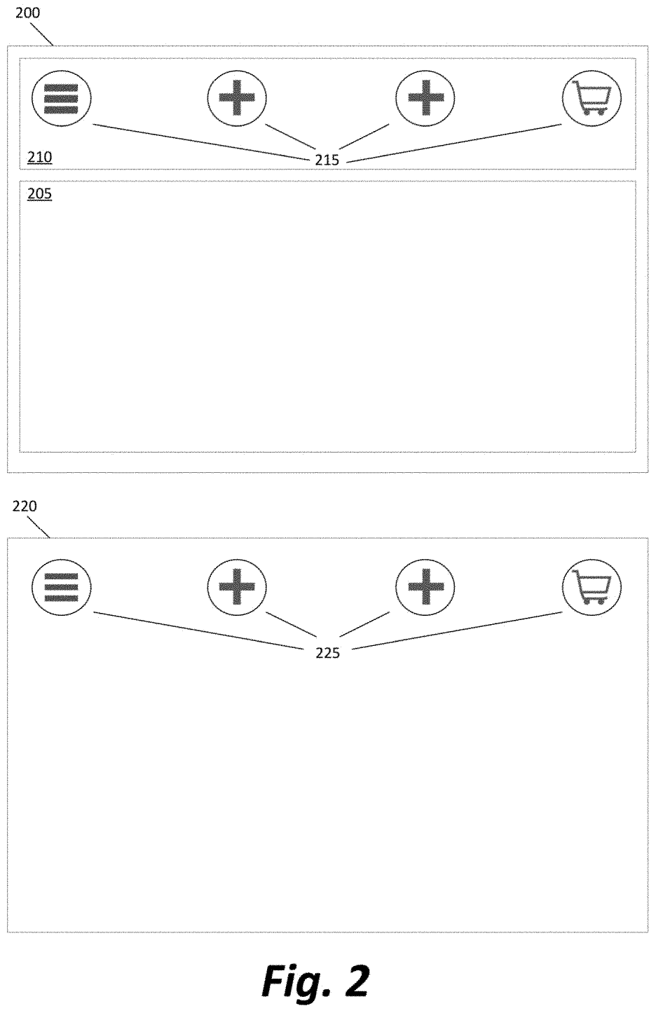

The browser may be navigated to a URL at a first domain provided by a first web server 105. A webpage at the first domain (200 in FIG. 2) may incorporate instructions to the user's browser to load an advertisement or other dynamic content supplied by an advertisement server 110 or other content server.

Finally, a second web server 115 may provide a second webpage or other user interface (220 in FIG. 2) that a user would be interested in interacting with. In a preferred embodiment, the second webpage would be a merchant website/shopping cart, but any interactive, web-based user interface could be involved, whether that is a web-based email client, a search engine, a social media page, online banking, or an interface for making an appointment or reservation.

Although in most typical use cases the servers 105, 110, and 115 are likely to be different devices, there is no reason that a single device could not serve the function of two or even three of the devices, since each device's primary role is to provide information when the browser on the user's computing device 100 requests it.

FIG. 2 depicts a pair of user interfaces that are modified and combined by means of methods and systems described herein.

The first webpage 200 includes a normal region for content 205, as well as, in a preferred embodiment, a top banner or side banner region for displaying the advertisement or other dynamic content 210.

The second webpage or user interface 220 provided by the second web server 115 includes some number of buttons or other user interface elements 225. In a preferred embodiment, the advertisement or other dynamic content 210 incorporates an identical set of buttons or user interface elements 215 so that the advertisement or other content almost appears to be a window directly into the second webpage or user interface 220, with the same look and feel.

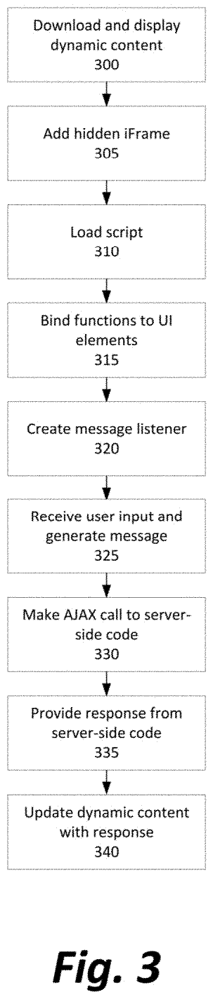

FIG. 3 depicts a method for augmenting the first webpage to add two-way, cross-domain communication with the second webpage on a different site and domain from the one being augmented.

When a user visits the webpage 200 in a browser on the user's computer 100, in accordance with the code of webpage 200, the browser downloads an advertisement or other content 210 from the advertisement server 110 and displays it within the webpage (Step 300).

After the content is loaded, a hidden iFrame is added to the webpage 200 (Step 305). In a preferred embodiment, the iFrame is completely hidden from the user and is invisible. In other embodiments, if browser or security settings prevent an invisible element from being created or from loading content, the iFrame may instead be arbitrarily difficult to see (for example, 1 pixel by 1 pixel in size) or placed in a location where it is unlikely to be seen (such as a bottom corner of the webpage). The hidden iFrame loads a webpage from the second webserver 115, from a URL at the second domain.

For example, while implementation of is not limited to use of Javascript, this could be accomplished with Javascript code as follows:

var helperIframe = document.createElement(“iframe”);
document.body.appendChild(helperIframe);
helperIframe.src = “https://www.example.com/”;

The newly-created iFrame is then used to load a script file including an executable program, such as a, such as (but not limited to) a Javascript file (Step 310) containing custom code for facilitating the cross-domain communication.

For example, a function that is within the Javascript file and becomes accessible to the digital advertisement 210 might read:

function sendMessage(itemid, index) {

var msg={“itemId” : itemid, “itemIndex” : index};
helperIframe.contentWindow.postMessage(msg,‘https://www.example.com’);

}

The function(s) provided in the custom code are bound to one or more elements of advertisement 210 (Step 315) so that interactions with the advertisement, including clicking, mouseovers, typing, dragging, etc. will cause the function(s) to be called.

For example:

var button1 = document.getElementsByClassName(“button1”)[0];
button1.addEventListener(“click”, function( )}

sendMessage(123472, 0)
button1.innerHTML=“Adding...”;

});

Additionally, the advertisement or other dynamic content 210 may be updated to include information from the second webpage, such as the items that are already in a shopping cart from a previous visit to the second webpage.

For example:

this.getcartContents = function( )]

var xhr = new XMLHttpRequest( );
xhr.open(“GET”, “www.example.com/cartinfo”, true);
xhr.setRequestHeader(“Content-Type”, “application/json”);
xhr.onreadystatechange = function( ) {

if (xhr.readyState == 4 && xhr.status == 200){

var json = JSON.parse(xhr.responseText);
if (json === “undefined” || json == null){

return;

}
else if (json.cartInfo.items === “undefined” ||
json.cartInfo.items == null){

return;

}
else{

that.cartCallBack(json);

}

}

}
xhr.send(null);

}

Within the second webpage 220 in the iFrame, a “message listener” is set up (Step 320). The message listener waits to receive messages specifically from the dynamic content 210 and only from that source. Any messages sent to the message listener from another source will be ignored.

For example:

window.addEventListener(“message”, function(event) {

var cartTotal = 0;
if (event.origin == “https://www.example.com”){

event.data.cartInfo.items.forEach(function(item){

cartTotal += item.qty;

});
that.cartCount.style.display=“block”;
that.cartCount.innerHTML=cartTotal;
if (that.buttons[event.data.itemIndex] != null)

that.buttons[event.data.itemIndex].cartButton.innerHTML =
“Add to cart”;

}

});

When a user interacts with the dynamic content 210 (for example, clicking on a product within an advertisement that has an “Add to cart” label), a message is sent from the dynamic content 210 to the message listener (Step 325). The message may contain information to be acted upon, such as a product id of the product to be added to the cart, credentials or tracking information from the user, or other relevant data.

When the message is received at the message listener, the iFrame containing the second webpage 220 makes an AJAX call or other function call that causes server-side code to be executed (Step 330) to fulfill some command or query that was requested by the user (for example, actually adding items to the user's cart on the second website). From the point of view of the second web server 115, there is no difference between the user navigating directly to the second website to perform the action and the user interacting with the advertisement or dynamic content 210.

For example:

this.addTocart = function(itemid, index)}

var msg={“items”:[{“itemId” : itemid, “qty”: 0}]};
var xhr = new XMLHttpRequest( );
var url = “https://www.example.com/addcart”;
xhr.open(“POST”, url, true);
xhr.setRequestHeader(“Content-Type”, “application/json”);
xhr.onreadystatechange = function ( ) {

if (xhr.readyState === 4 && xhr.status === 200) {

var json = JSON.parse(xhr.responseText);
json.itemIndex = index;
that.cartCallBack(json);

}

};
var data = JSON.stringify(msg);
xhr.send(data);

}

}

Code running within the iFrame receives and processes the request:

window.addEventListener(“message”, function(event) {

if (event.origin == “http://localhost:5100”){

cart.addTocart(event.data.itemId, event.data.itemIndex);

}

});

After the server-side code is executed, a response is provided (Step 335) to indicate the success or failure of processing the request, and any other relevant information in the response. For example, a response to a request to add to a shopping cart may include both an indicator of success and a current number of items in the cart and/or the total value of purchases in the cart.

When the response is received, the advertisement or dynamic content 210 is updated (Step 340) to reflect the information received. There may be, for example, a shopping cart displayed that looks identical to how the shopping cart would appear if the user had directly navigated to the second webpage to shop for items. The update may also include a success or error message or other information in addition to mimicking the second webpage.

As a result of these features, a user visiting a first webpage can interact with advertisements or other dynamic content that not only have the “look and feel” of a second webpage, but that actually update the user's cart or other session on the second webpage, without the user having to navigate the browser to the second webpage.

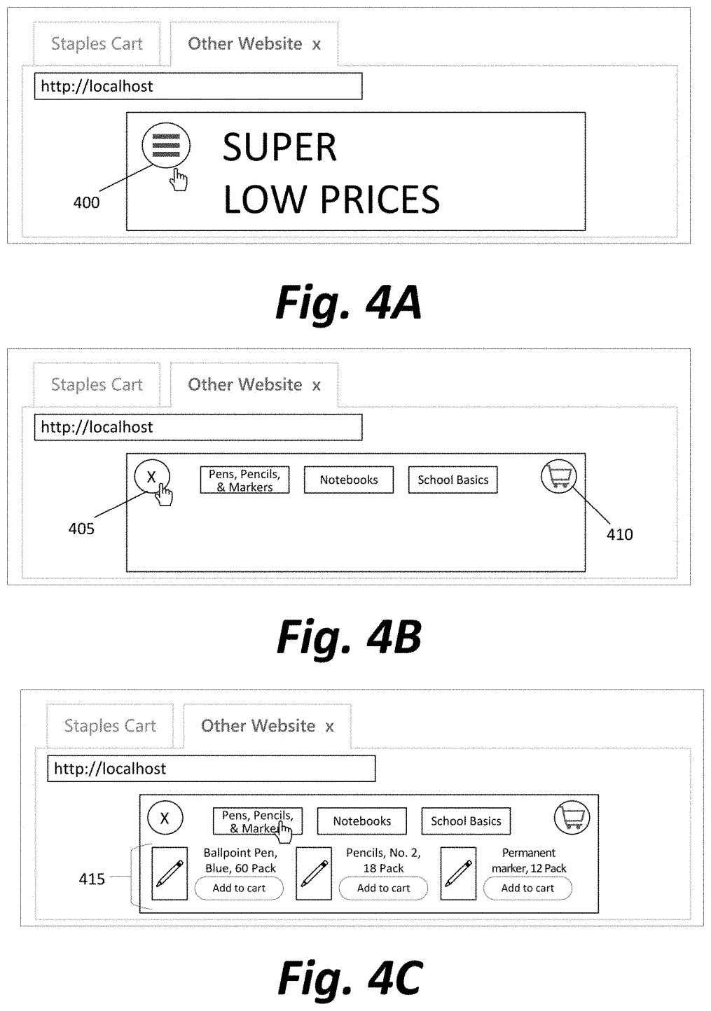

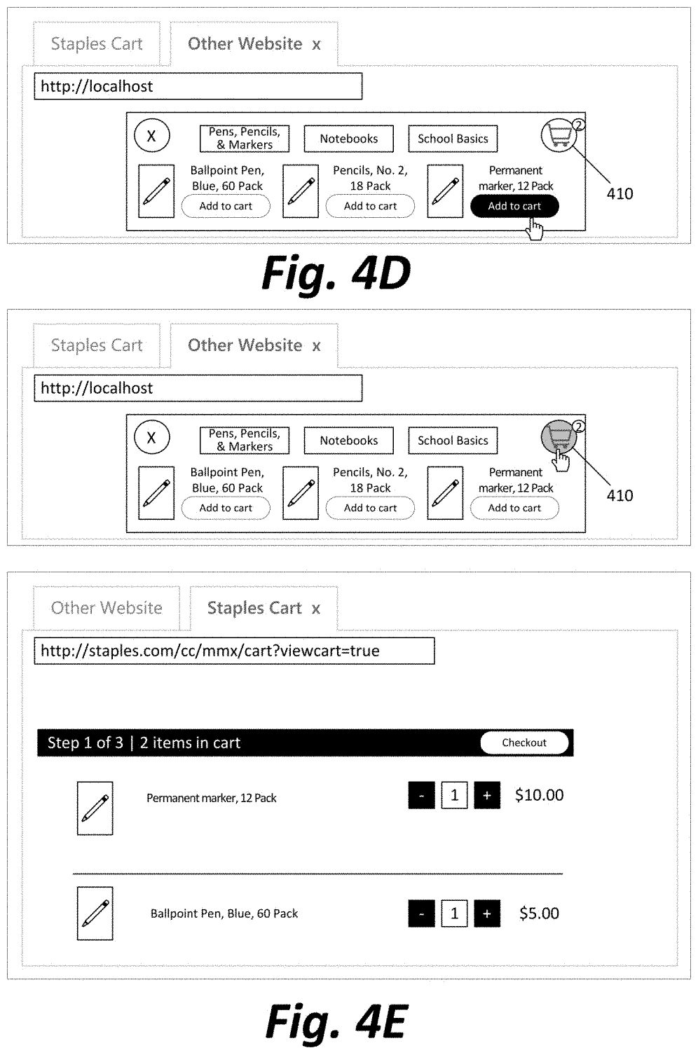

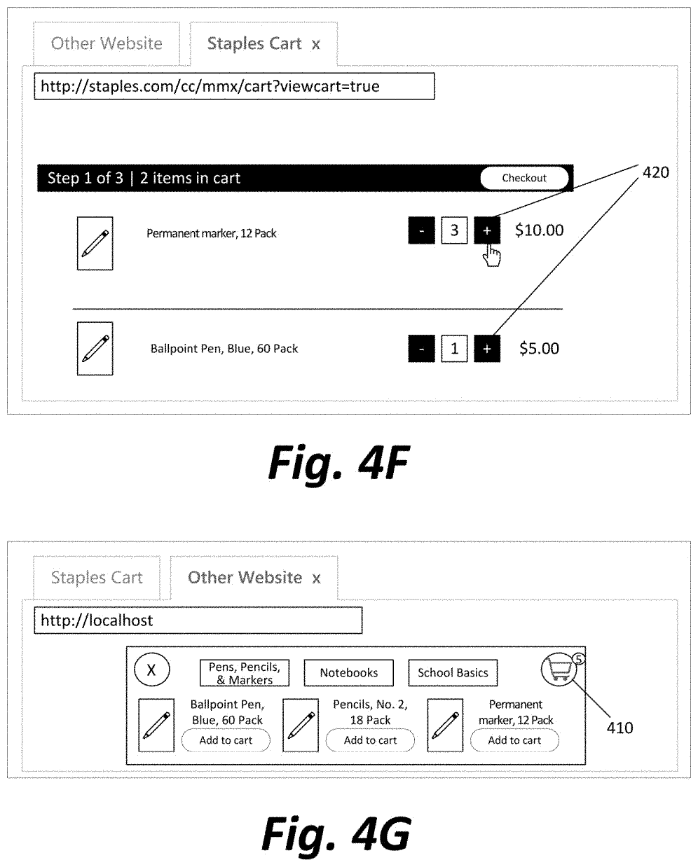

FIGS. 4A-4G depict a representative concrete user experience that may be accomplished using the presently described technology.

In FIG. 4A, a digital advertisement is loaded on a webpage, including a “hamburger” menu icon 500.

In FIG. 4B, upon clicking or tapping the icon 500, multiple product categories are displayed, as well as an exit icon 505 and a cart icon 510.

In FIG. 4C, clicking a product category causes a second row of elements 515 to be added, indicating a series of items that can be added to a cart.

In FIG. 4D, clicking any of the “Add to cart” buttons will actually cause cart icon 510 to be updated to indicate items have been added.

In FIG. 4E, if the user clicks on the cart icon 510, the browser will navigate to the second website (pictured below) and display the traditional cart, containing the items the user had added through the advertisement.

In FIG. 4F, the user may change the number of items in the cart using increase or decrease buttons 520.

In FIG. 4G, if the user returns to the original webpage and views the advertisement again, the cart icon 510 will have updated to reflect the current number of items in the cart, even though the advertisement was not used to add or remove the items most recently changed.

Any changes that are made in either interface are reflected in the other automatically, resulting in a seamless user experience despite the webpages being on two different domains.

Other possible applications of the presently-described technology may include interactive polling (where a user can vote on a political/sports/entertainment option and see the votes of others in real time), interactive games with other players, streamlined communications interfaces such as instant messaging or social media, and

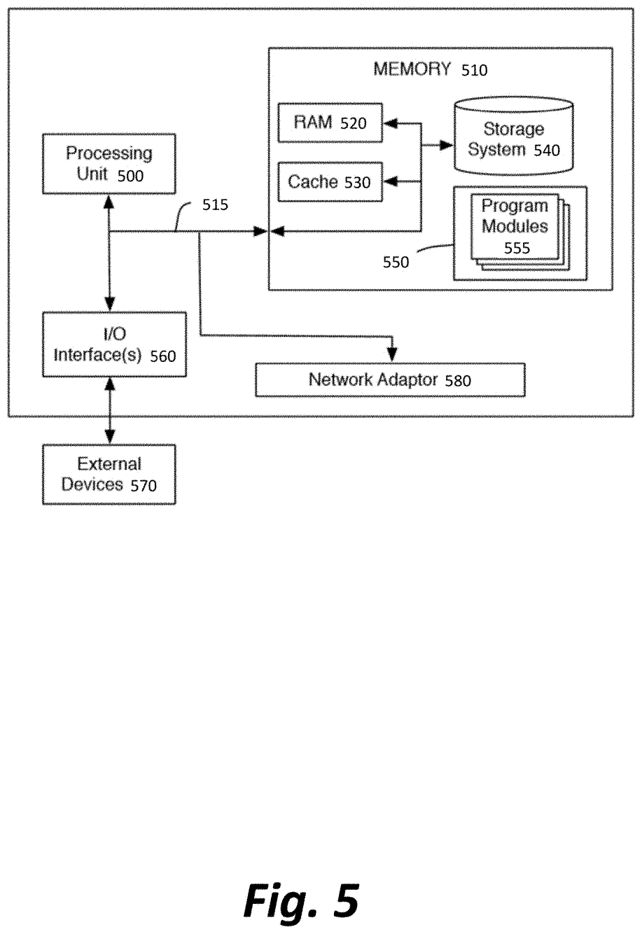

Although FIG. 1 depicts a preferred configuration of computing devices to accomplish the software-implemented methods described above, those methods do not inherently rely on the use of any particular specialized computing devices, as opposed to standard desktop computers and/or web servers. For the purpose of illustrating possible such computing devices, FIG. 5 is a high-level block diagram of a representative computing device that may be utilized for each of the computing devices and/or systems to implement various features and processes described herein. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 5, the components of the computing device may include (but are not limited to) one or more processors or processing units 500, a system memory 510, and a bus 515 that couples various system components including memory 510 to processor 500.

Bus 515 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 500 may execute computer programs stored in memory 510. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 500 may be used.

The computing device typically includes a variety of computer system readable media. Such media may be any available media that is accessible by the computing device, and it includes both volatile and non-volatile media. removable and non-removable media.

System memory 510 can include computer system readable media in the form of volatile memory, such as random access memory (RAM) 520 and/or cache memory 530. The computing device may further include other removable/non-removable, volatile/non-volatile computer system storage media. By way of example only, storage system 540 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 515 by one or more data media interfaces. As will be further depicted and described below, memory 510 may include at least one program product having a set (e.g., at least one) of program modules that are configured to carry out the functions of embodiments described in this disclosure.

Program/utility 550, having a set (at least one) of program modules 555, may be stored in memory 510 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 570 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 560.

In addition, as described above. the computing device can communicate with one or more networks, such as a local area network (LAN), a general wide area network (WAN) and/or a public network (e.g., the Internet) via network adaptor 580. As depicted, network adaptor 580 communicates with other components of the computing device via bus 515. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of modifying a first webpage from a first domain to enable cross-domain two-way communication, comprising:
causing a web browser to load, as part of the first webpage, dynamic content comprising one or more user interface elements;
causing the web browser to embed an iFrame into the first webpage that contains a second webpage from a second domain different from the first domain, and wherein the one or more user interface elements each share a function with user interface elements of a third webpage, also from the second domain, the user interface elements of the third webpage being native to the third webpage rather than being embedded in any iFrame created by the third webpage;
causing the web browser to load a script file from within the iFrame;
subsequent to the embedding of the iFrame and loading the script file within the iFrame, causing the web browser to bind one or more functions defined by the script file to the one or more user interface elements, the one or more functions including the web browser's Window.postMessage( ) functionality;
causing the web browser to, in response to the user interacting with the one or more user interface elements, use the one or more functions to send a post message to the second domain;
upon receipt of the post message, updating a state of the user interface elements of the third webpage to match a changed state of the one or more user interface elements of the first webpage;
causing the web browser to receive a message from a server at the second domain using the web browser's Window.addEventListener( ) functionality indicating that a state of the one or more user elements of the third webpage has been further changed through a user interaction on the third webpage; and
in response to the received message, updating the one or more user interface elements of the first webpage to match the further changed state of the user interface elements of the third webpage.

2. The method of claim 1, wherein the one or more user interface elements have an identical appearance to the user interface elements of the third webpage.

3. The method of claim 2, wherein the third webpage from the second domain is an online shopping cart page showing items that have been added to a cart.

4. The method of claim 1, wherein the post message sent to the second domain is structured so that the server at the second domain cannot determine that it was sent from within a webpage provided by the first domain.

5. The method of claim 1, further comprising:
causing the web browser to, when subsequently loading the first webpage, update the one or more user interface elements to reflect the further changed state.

6. The method of claim 5, wherein the third webpage comprises an online shopping cart, and wherein the further changed state is an addition or removal of one or more items to or from the online shopping cart.

7. The method of claim 5, further comprising:
causing a web browser to, when subsequently loading the third webpage, update the third webpage to reflect the changed state.

8. (canceled)

9. The method of claim 1, wherein the iFrame is embedded into the first webpage and is not visible to the user.

10. The method of claim 1, wherein the iFrame is hidden among other elements of the first webpage as a result of the iFrame having a size with a dimension of only one pixel or a location at a bottom of the first webpage.

11. A system for causing modification of a first webpage from a first domain to enable cross-domain two-way communication, comprising:
one or more processors, and
non-transitory memory storing instructions that, when executed by the one or more processors, cause the one or more processors to:
cause a web browser to load, as part of the first webpage, dynamic content comprising one or more user interface elements;
cause the web browser to embed an iFrame into the first webpage that contains a second webpage from a second domain different from the first domain, and wherein the one or more user interface elements each share a function with user interface elements of a third webpage, also from the second domain, the user interface elements of the third webpage being native to the third webpage rather than being embedded in any iFrame created by the third webpage;
cause the web browser to load a script file from within the iFrame;
subsequent to the embedding of the iFrame and loading the script file into the iFrame, cause the web browser to bind one or more functions defined by the script file to the one or more user interface elements, the one or more functions including the web browser's Window.postMessage( ) functionality;
cause the web browser to, in response to the user interacting with the one or more user interface elements, use the one or more functions to send a post message to the second domain;
upon receipt of the post message, update a state of the user interface elements of the third webpage to match a changed state of the one or more user interface elements of the first webpage;
cause the web browser to receive a message from a server at the second domain using the web browser's Window.addEventListener( ) functionality indicating that a state of the one or more user elements of the third webpage has been further changed through a user interaction on the third webpage; and
in response to the received message, update the one or more user interface elements of the first webpage to match the further changed state of the user interface elements of the third webpage.

12. The system of claim 11, wherein the one or more user interface elements have an identical appearance to user interface elements of the third webpage.

13. The system of claim 12, wherein the third webpage from the second domain is an online shopping cart page showing items that have been added to a cart.

14. The system of claim 11, wherein the post message sent to the second domain is structured so that the server at the second domain cannot determine that it was sent from within a webpage provided by the first domain.

15. The system of claim 11, wherein the instructions, when executed by the one or more processes, further cause the one or more processors to:
cause the web browser to, when subsequently loading the first webpage, update the one or more user interface elements to reflect the further changed state.

16. The system of claim 15, wherein the third webpage comprises an online shopping cart, and wherein the further changed state is an addition or removal of one or more items to or from the online shopping cart.

17. The system of claim 15, wherein the instructions, when executed by the one or more processes, further cause the one or more processors to:
cause a web browser to, when subsequently loading the third webpage, update the third webpage to reflect the changed state.

18. (canceled)

19. The system of claim 11, wherein the iFrame is embedded into the first webpage and is not visible to the user.

20. The system of claim 11, wherein the iFrame is hidden among other elements of the first webpage as a result of the iFrame having a size with a dimension of only one pixel or a location at a bottom of the first webpage.
